(19) United States
(12) Patent Application Publication
(10) Pub. No.: US 2011/0018229 A1
(43) Pub. Date: Jan. 27, 2011

(54) Passenger comfort strap, used on motorized and or non-motorized devices. Biker buddy comfort strap

(76) Inventor: John James Gizzarelli, JR., Port Saint Lucie, FL (US)

Correspondence Address: John J. Gizzarelli, 407 S.E. Cork Rd., Port Saint Lucie, FL, 34984, US

(21) Appl. No.: 12/803,807

(22) Filed: Jul. 7, 2010

Related U.S. Application Data
(60) Provisional application No. 61/271,747, filed on Jul. 24, 2009.

(51) Int. Cl. B62J 27/00; B62J 99/00

(52) U.S. Cl. 280/288.4

(57) ABSTRACT

A strap assembly that is not attached to a motorcycle, or any other gas or diesel powered device, or non-powered device for example a horse, bull , etc. The strap assembly attaches to the driver by means of two steel o-rings which are slid through the drivers belt and must be positioned behind the drivers front belt loops. The strap then must be slid through each steel o-ring which are located behind each front belt loop of drivers pants and be positioned so center portion of strap is in between both front belt loops. The end loops must be located on either side of drivers waist area extending rearwardly, allowing the passenger to grasp outside perimeter of each loop. Entire strap is made from flexible components to ensure a comfortable position for the driver and passenger.

### CROSS REFERENCE RELATED APPLICATION

This application is based on the provisional application No. 61271747 filed on Jul. 24, 2009.

Most motorized and non-motorized devices have an elongated seat and are able to accommodate two riders, a driver and a rear passenger. The driver or operator maintains proper balance and a comfortable position by means of holding onto the said steering assembly. The passenger of said device in most circumstances must hold onto said drivers waist or stomach area. This means of holding onto said driver is usually inadequate and creates a posture for the driver and passenger which can be very intimate and awkward for both, Also uncomfortable on long and or short rides for both the driver and passenger. In addition the passenger must have intimate contact with said operator of said device. In addition in some circumstances the operator may have a large stomach and or waist area which could make it difficult for the passenger to hold onto the driver of said device. In all of these cases as well as others, a need exist for some form of a strap with loops which does not attach to the device. It attaches to the driver or operator only. Said device in know way attaches to the passenger. The outside perimeter loops of said strap are grasp by the passengers hands and said strap can be utilized to provide a more comfortable position for the driver and passenger riding on a motorized or non motorized device. With this invention said strap is comprised of a continous steel cable or similiar man made or natural material positioned in a configuration resembling a figure eight. With configuration in proper position, ferrules will be used to form a first loop and a second loop at the opposite end of the first loop with a center span in between both first and second loops. Continous cable or similiar material will be ferruled in the center span where both ends of material come together. All ferrules will be swagged to ensure said strap retains proper position. Cable or similiar man made or natural material will then be encased in a variety of finishes including but not limited to leather, split suedes, ropes, rubber, plastic, etc. To form a variety of finished appearances. Leather, split suede, and rope finishes will be hand or machine braided to give a visually attractive finish. Various Rubbers and or plastics will be injected molded over said configuration. Steel o-rings will be provided which must be slid through drivers belt and be positioned behind drivers front belt loops. Driver can now secure belt as desired. With steel o-rings in correct position said strap will now be slid through both steel o-rings and driver must manually position center span of said strap in between drivers two front belt loops. Driver must now position said first and second end loop rearwardly on either side of waist area to provide the passenger to grasp each outside perimeter loop with their hands. The Steel o-rings provide a quick and easy way for the operator to remove said strap when not in use, also enables the passenger to release their hands from said strap when not in use, which will allow said strap to stay affixed to driver or operator of the motorized or non motorized device.

### OBJECT OF INVENTION

Accordingly, a primary object of the present invention is to provide a structure which is not attached to a motorized or non-motorized device, but which is attached to said driver, which can be grasp by both hands of a rear passenger on the said device to provide a comfortable position for the driver and passenger. Another object of the present invention is to provide the passenger of a motorized or non-motorized device to easily use it on any other type of motorized or non-motorized device. Another object of the invention is to provide a device which can be removed quickly and easily by the driver when not in use. Another object of the invention is to provide a visually attractive device which will not be bulky and can be stored away easily when not in use. Another object of the present invention is to provide a device which is visually attractive and is not complicated and time consuming to install and use on motorcycles, and various other motorized and or non motorized devices.

### FIELD OF INVENTION

The following invention relates to devices that are not needed to be attached to any motorized or non-motorized device. More particularly this invention relates to a device which is attached to only the driver by means of two steel o rings, which must be slid through drivers belt and be positioned in between the two front belt loops, with said strap loops positioned rearwardly. The passenger must grasp outside perimeter of both end loops, while riding on the back of a motorized or motorized device. Said strap will provide support for the hands of a rear passenger and a more comfortable position for the driver and passenger while riding on a motorized or non-motorized device

### BRIEF SUMMARY OF INVENTION

With said invention the biker buddy passenger comfort strap provides the passenger and driver a more comfortable position on long and short rides. Said assembly provides a position for said driver and passenger to have a less intimate contact if desired.

### SUMMARY OF INVENTION

With this invention said strap assembly provides a more comfortable and enjoyable position for said driver and passenger riding on a motorized or non motorized device. Strap assembly provides two looped handle areas for passenger to grasp outside perimeter of sed loops located on either side of said strap assembly. The strap assembly consist of a first loop, center span, and then a second loop located on the opposite side of the first loop. The strap is made with a steel cable, and or similiar man made or natural material. Ferrules are then used to create both loops and ferrules are used in center span to attach both ends of the continous steel cable and or similiar man made or natural material. When the said assembly is in the correct form similiar to the number eight. The cable is then encased and finished in a variety of finishes consisting of but not limited to a flexible rubber, leather braid, split suede hides, variety of ropes, and other similiar materials to provide an attractive and comfortable finished product. Two steel o-rings are provided with said strap which slide through drivers belt and are to be positioned behind both front belt loops of drivers pants. Strap assembly will then be slid through each steel o-ring and be positioned where as center span is located in between drivers front belt loops and each loop is located on opposite sides of drivers waist area facing rearwardly. Steel o-rings enable the driver to easily and quickly remove the strap assembly when not being used. This invention provides a more comfortable position for said driver and passenger when riding on a motorized or non motorized device.

### BRIEF DESCRIPTION OF THE DRAWINGS

FIG. 1.) Number three depicts an illustration of the configuration of the internal steel cable or similiar man made or natural material positioned in a figure eight. The numbers 4, 5, 6, shows the areas where it is ferruled and swagged to retain its position. The numbers 7,8,9,10, illustrates depicts the overall configuration of said invention.

FIG. 2.) numbers 3, 11,12,13, depicts the invention with a finished material including but not limited to leather, split suede, ropes, rubbers, plastics, and a variety of other man made or natural materials. The materials mentioned above will be hand braided by human hands, and or braided by machine, and or molded over said assembly. All of the variety of finishes in FIG. 2.) will encase the assembly in FIG. 1.)

FIG. 3.) number 18 shows the leather or suede sleeve which will slide over either end loop and be positioned in the center span area of FIG. 2.) number 18 in FIG. 2 illustrates the position of said sleeve.

FIG. 4.) number 3 illustrates the position of said invention attached to the driver depicted in the letter A.) by means of two steel o rings slid through drivers belt and positioned behind drivers two front belt loops which allows said strap to be manually slid through both said steel o rings by the driver and said loops will be positioned rearwardly. FIG. 4.) letter B illustrates the passenger grasping the outside perimeter of both loops of said strap which are located on the right and left side of the drivers waist area. FIG. 4.) letter C illustrates the motorized or non motorized device which the driver and passenger or riding on.

### DETAILED DESCRIPTION OF THE INVENTION

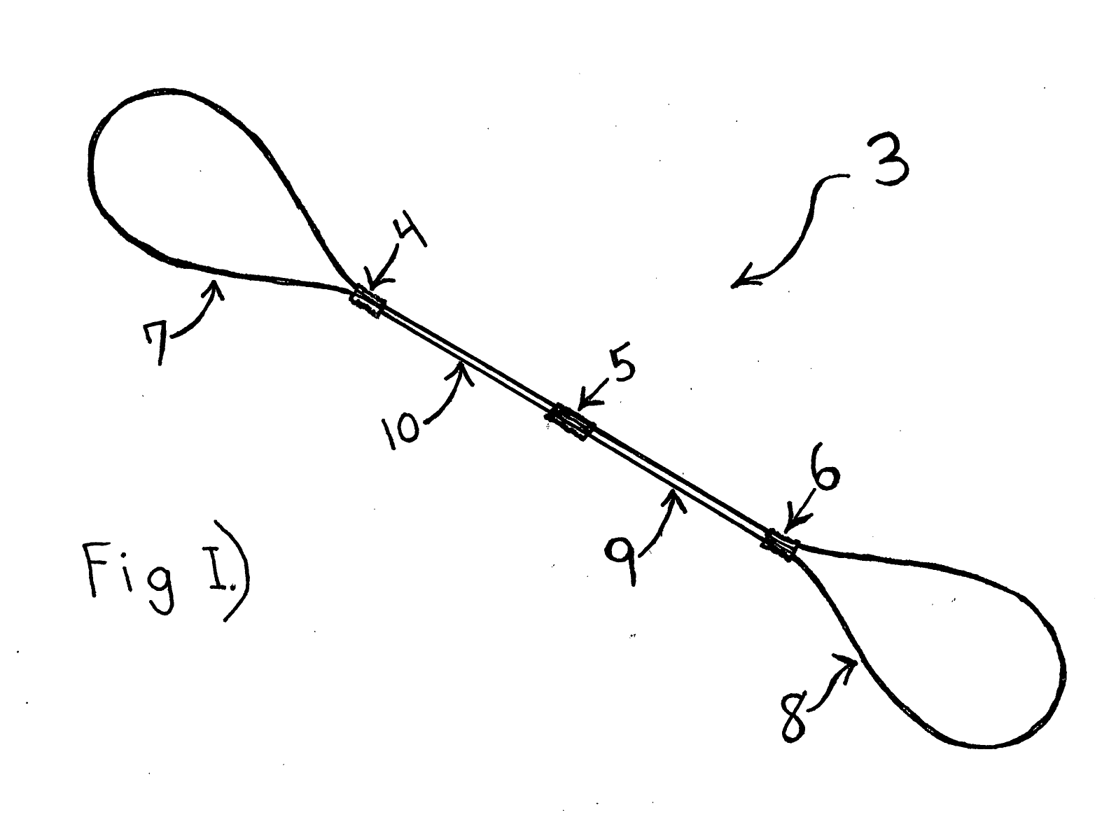

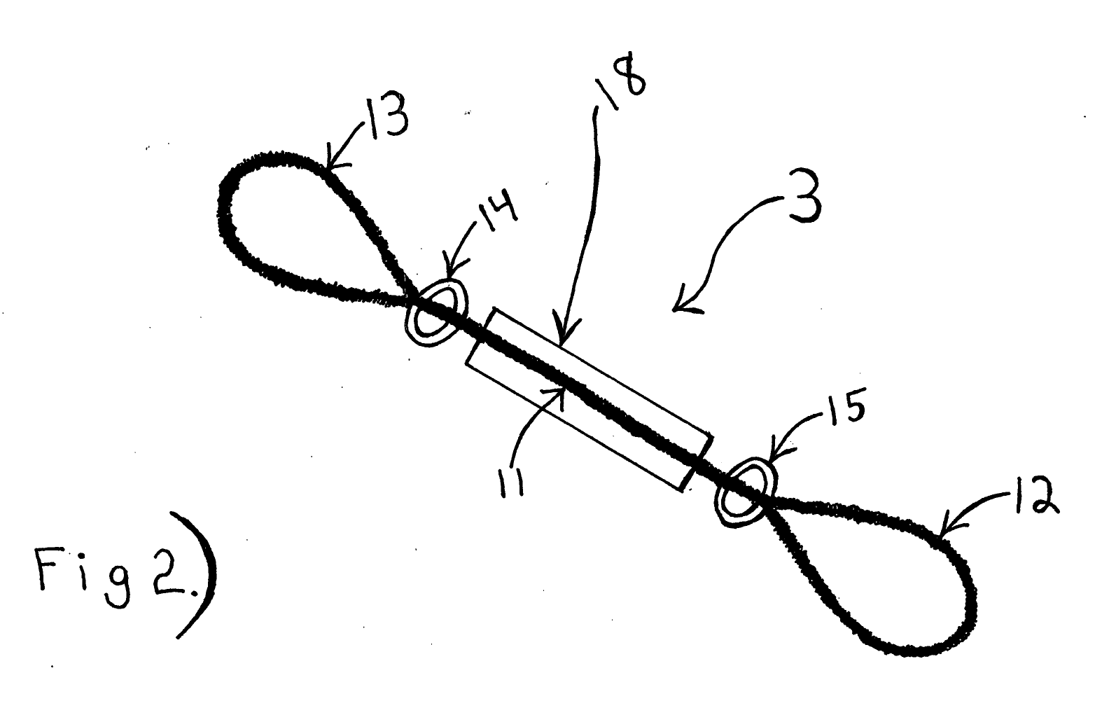

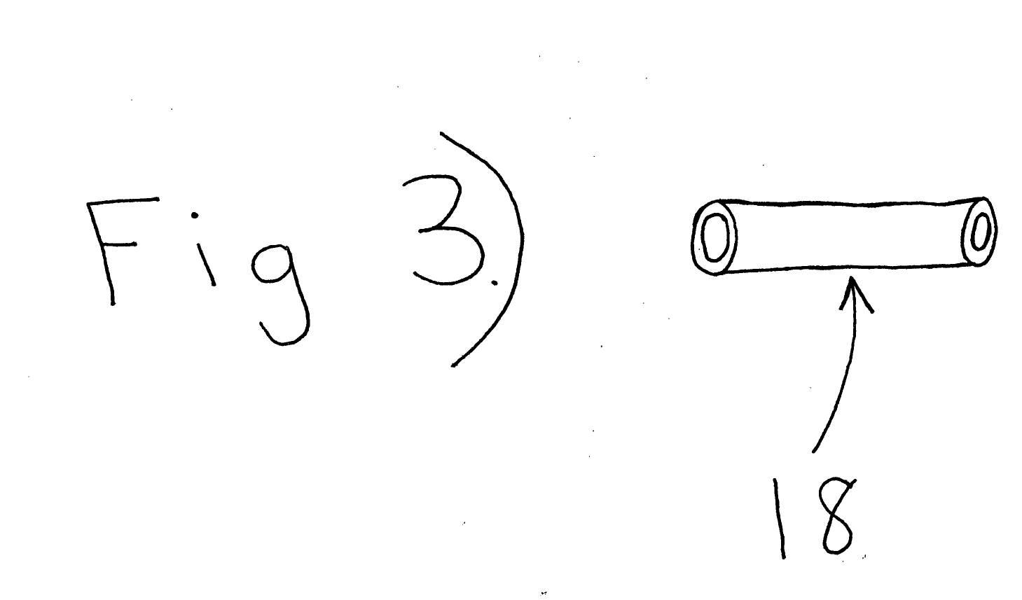

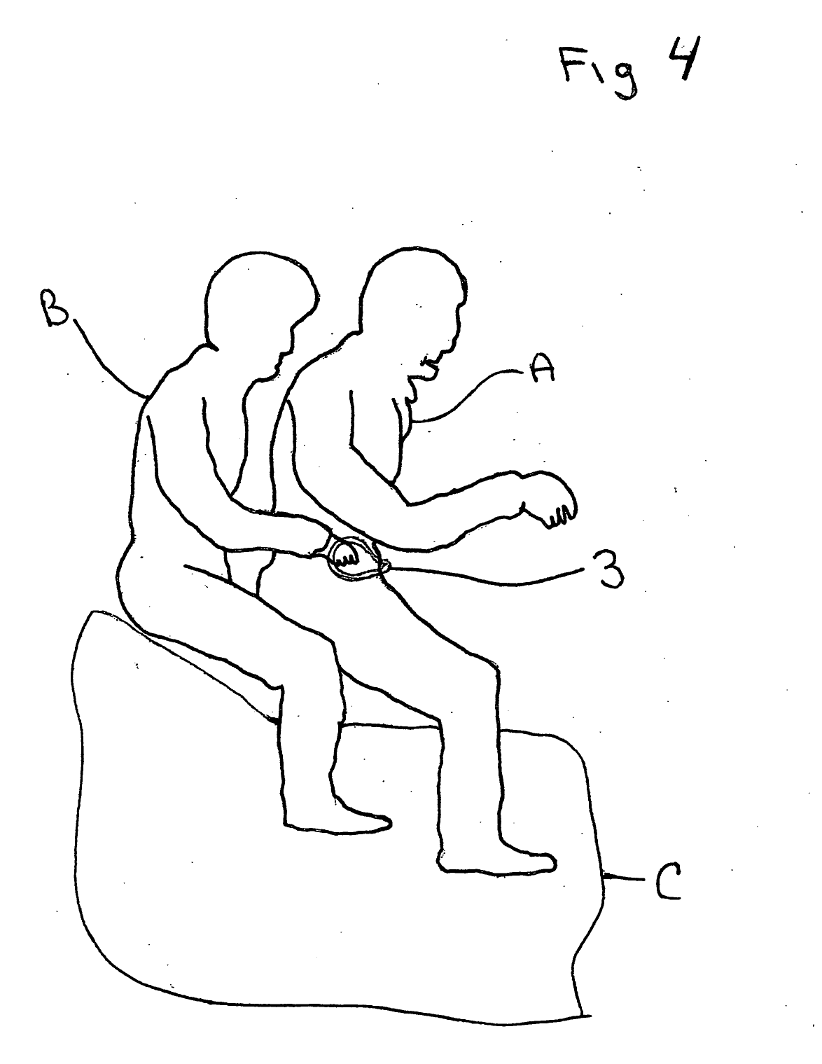

FIG. 1. number 3. Is a perspective view of a preferred embodiment of the invention which illustrates the internal steel cable or similiar man made or natural continous material in a specific configuration as shown with numbers 7,8,9,10. The material can range in a diameter from 1/16 of an inch to ⅜ of an inch. FIG. 1. numbers 7, 8, illustrates a loop at each end of the center span of the said assembly. FIG. 1. numbers 9,10, illustrates the center span of the said assembly. FIG. 1. numbers 4, 5, 6, illustrates where the said assembly is secured with a ferrule by means of using a swagging tool to ensure proper configuration. FIG. 1 numbers 4,5,6, shows where ferrules will be used in accordance with said assembly diameter. FIG. 1. number 3 shows continous length of material set in a position to maintain a specific shape and length. FIG. 1. number 5 illustrates where a ferrule is positioned at the center span which will be crimped using a swagging tool to ensure both ends of the continous assembly are secure. FIG. 2. illustrates the finished said assembly (passenger comfort strap.) FIG. 2. number 3 is an illustration of the passenger comfort strap finished with a variety of materials as follows; flexible rubber, braided rope materials, braided leather lace materials, braided split suede lace material, and also but not limited to other materials used to provide a comfortable and visually attractive finished assembly. FIG. 2. numbers 14,15, illustrates steel o-rings which are included with the said assembly. Steel o-rings must be slid through drivers belt and must be positioned behind each front belt loop. Driver must secure belt as desired. FIG. 2. numbers 14,15, allows the biker buddy comfort strap to be attached to the drivers belt by means of the two steel o rings. FIG. 2. number 11,12,13 illustrates the center span and both end loops located on opposite sides of the center span finished in a variety of finishes including but not limited to flexible rubber, braided leather, rope material, split suede laces, and also a variety of other man made and or natural materials. FIG. 2. number 18, illustrates a removable leather and or suede sleeve which can be manually slid over either end loop and be positioned in the center portion of said assembly. Said sleeve will display a logo trademarked name reading (biker buddy.) FIG. 3 number 18 illustrates a removable sleeve made from leather, suede, or similiar material. FIG. 3 number 18 is in no way needed to utilize the passenger comfort strap. It is a sleeve with a trademark reading as follows (biker buddy.) FIG. 2. number 18 illustrates the position of the said sleeve which can slide over either end loop and be positioned in the center of FIG. 2. number 11 which is located in center span of the said assembly. FIG. 4. illustrates a driver by letter A and the passenger by letter B on a motorized or non-motorized device. FIG. 4. number 3 illustrates the correct position of said assembly illustrated in FIG. 2. number 3 attached to the drivers belt by means of two steel o rings. FIG. 4 illustrates the passenger firmly grasping the outside perimeter of end loops with their right and left hands. FIG. 4 number 3 illustrates said assembly being positioned around drivers stomach and or waist area. Said assembly is in no way physically attached to the motorized or non-motorized device. Said assembly is in no way attached to the passenger, it is grasped by the passengers hands.

We claim:

1. A strap assembly comprising, in combination: A first loop on one end, with a center span, and a second loop on the opposite end with Said first loop adapted to be grasped by the passengers hand and Said second loop adapted to be grasped by the second hand of the passenger, Both loops will provide a handle type area for said passenger to grasp outside perimeter of both said end loops while riding on the back of a motorized or non motorized device.

2. The assembly of claim 1 wherein the strap is first comprised of a countinous steel cable or various other types of natural and or man made material configured in a shape to form a loop on either side of a center span area.

3. The assembly of claim 1 wherein the cable or other material can consist of various diameters of said cable or other materials including but not limited to steel, rope, plastics, rubbers, man made and or natural materials.

4. The assembly of claim 1 wherein the finished configuration of said configuration will then be encased by various types of material including but not limited to man made and or natural materials such as leathers, ropes, split suedes, rubbers, plastics, etc.

5. The assembly of claim 1 wherein the encased cable will be finished with various man made and or natural materials to provide an attractive appearance and a durable finished assembly.

6. The assembly of claim 1 wherein the center span area will include a leather and or suede sleeve located in the center portion of the said assembly with a trademarked logo reading (biker buddy.)

7. A strap assembly comprising in combination: wherein said strap assembly will be positioned manually by driver or operator by means of two steel o rings which must be slid through drivers belt, then belt must be fastened and steel o rings must be positioned behind both front belt loops allowing said strap to be slid through each steel o ring with end loops facing rearwardly on either side of driver or operators waist area.

8. The assembly of claim 7 will also allow the passenger to release their hands of said assembly when not riding on the back of a motorized or non motorized device.

9. The assembly of claim 7 will allow the said strap portion of assembly to be stored away quickly and easily when not in use.

10. The assembly of claim 7 , will allow the strap to be removed quickly and easily by operator or driver of the motorized or non motorized device when not in use.

11. The assembly of claim 7 wherein said strap assembly is adapted to not attach to any motorized or non motorized device.

12. The assembly of claim 7 wherein said strap assembly is adapted to be manually attached to the driver or operator of a motorized or non motorized device.
